(19) United States
(12) Patent Application Publication
(10) Pub. No.: US 2013/0122601 A1
(43) Pub. Date: May 16, 2013

(54) Method for Detecting Content of Chitosan Fiber in Textile

(71) Applicants: Jiacun Zhou, Taian (CN); Guangmin Hu, Taian (CN)

(72) Inventors: Jiacun Zhou, Taian (CN); Guangmin Hu, Taian (CN)

(73) Assignee: SHANDONG HUAXING TEXTILE GROUP CO.,LTD., Taian (CN)

(21) Appl. No.: 13/643,551

(22) PCT Filed: Mar. 24, 2011
(86) PCT No.: PCT/CN2011/071932

§ 371 Date: Jan. 29, 2013

(30) Foreign Application Priority Data
Apr. 29, 2010 (CN) 201010159468.7

(51) Int. Cl. G01N 31/16

(52) U.S. Cl. CPC G01N 31/16; G06F 19/70
USPC 436/94; 702/23

(57) ABSTRACT

The technical solution of the present invention provides a method for measuring content of chitosan fiber in textile by using a series of equations. The method calculates the content of chitosan fiber in textile according to the following equations:

W₁=C×f×(V₁−V₂)×0.001×161.15×100/W₃

W₂=C×f×(V₁−V₂)×0.001×203.19×100/W₃×(1−D·D)/D·D

g=(W₁+W₂)/W×100%

The error is very small in this method. Besides, a highly sensitive, simple, and fast method for measuring content of chitosan fiber in textile is established.

### CROSS-REFERENCE TO RELATED APPLICATION

This application is the U.S. national phase of International Application No. PCT/CN2011/071932, filed on 24 Mar. 2011, which claims the priority benefit of Chinese Patent application No. 201010159468.7, filed on Apr. 29, 2010, the entire contents of which is hereby incorporated by reference.

### BACKGROUND OF THE INVENTION

1. Field of the Invention

The present invention relates to a method for measuring content of chitosan fiber, and in particular to a method for measuring content of chitosan fiber in textile.

2. Background of the Invention

Chitosan is the only polymer which is positively charged in nature. In recent years, chitosan has found increasingly applications in the field of chemical industry, environmental protection, foods, medicines, cosmetics, agricultural industry, or the like. Since chitosan has a significant antibacterial and hemostatic function, it is applied gradually to textiles like underclothes, socks. However, there is no method for measuring accurately the content of the effective constituent of chitosan in the functional textile made from chitosan. Therefore, how to measure content of chitosan fiber in textile is not only a problem that needs to solve, but also a bottleneck for the national quality supervision department to supervise the textile containing chitosan fiber. This problem always restricts the development of chitosan fiber in our country and there is an urgent need for solving such problem.

### BRIEF SUMMARY OF THE INVENTION

It is an object of the present invention to provide a method for measuring content of chitosan fiber in textile, and establish a method for measuring content of chitosan fiber in textile which is highly sensitive, simple, and fast.

The theoretical basis for the present invention lies in that colloid titration is a volumetric analysis method for measuring polyelectrolyte charged groups in an aqueous solution. Chitosan dissolves in a diluted acid, is positively charged by combining an acid molecule to the amino group or by combing an H⁺, and thus develops into a positively charged polyelectrolyte.

When the polyelectrolyte encounters an oppositely charged polyelectrolyte in the aqueous solution, a charge neutralization reaction takes place between them in a certain stoichiometric relationship, producing a neutral association complex which will finally form precipitates.

It is the theoretical basis for measuring content of amino in chitosan by colloid titration that a charged electrolyte with a known chemical structure, molecular weight and concentration is used to measure the amount of charged groups in chitosan, in which the titration end-point is determined by visual observation.

In this method, an anionic polyelectrolyte of potassium polyvinyl sulfate (PVSK) is used as a titrant, and a positively charged blue organic dye of Toluidine Blue (T.B) is used as an indicator. The reason Toluidine Blue is used as the indicator lies in that it is positively charged and does not react in a charge neutralization reaction with chitosan in an acid solution, while it can be combined with the negatively charged PVSK. However, this combination lags behind the reaction between the positively and negatively charged polyelectrolytes. The solution is blue prior to the titration end-point. While at the end-point, excessive PVSK reacts immediately with Toluidine Blue, so as to turn the solution from blue to purplish red and to form flocculent precipitates. Since the change in color is very sensitive, it is possible to determine the titration end-point accurately.

Based on the above theory and the object of the present invention, the following technical solution is adopted in the present invention:

a method for measuring content of chitosan fiber in textile, characterized in that, the method comprises:

step 1: weighing a textile to be measured of a constant weight not more than 2 g, putting into a conical flask, adding 100 ml 1% acetic acid solution to dissolve chitosan fiber in the textile to be measured, and getting ready for use;

wherein during the step of dissolving, it is preferably to stir the textile to be measured for 4 hours, and then stand for 0.5 hour, so that the chitosan fiber in the textile to be measured sufficiently dissolves in the acetic acid solution;

step 2: weighing the resulting solution in step 1 and putting into another conical flask, further adding deionized water, then adding an indicator of Toluidine Blue, and getting ready for use;

step 3: putting a magnetic rotor into a conical flask containing the resulting solution in step 2, putting the conical flask over a magnetic stirrer; titrating a PVSK titrant and stirring at the same time, and reading the titration volume V₁ of PVSK titrant at the titration end-point, wherein the titration end-point is defined as a time instant at which the solution turns from blue to purplish red, does not fade in 20 seconds, and forms flocculent precipitates;

wherein during titrating the PVSK titrant, it is preferably to control the titration rate at 0.03 ml/s, since the phenomenon of temporary titration end-point tends to appear in case the titration rate is too large;

step 4: getting deionized water with the same amount as that in step 2, carrying out a blank titration in the same manner as described above, and reading the titration volume V₂ of PVSK titrant;

step 5: calculating the content of chitosan fiber in textile according to the following equations:

W₁=C×f×(V₁−V₂)×0.001×161.15×100/W₃

W₂=C×f×(V₁−V₂)×0.001×203.19×100/W₃×(1−D·D)/D·D

g=(W₁+W₂)/W×100%

The technical effects of the present invention follow. The technical solution of the present invention provides a method for measuring content of chitosan fiber in textile by using a series of equations. The error is very small in this method. Besides, a highly sensitive, simple, and fast method for measuring content of chitosan fiber in textile is established.

C molar concentration of PVSK titrant, 0.0025 mol/L

f coefficient of PVSK titrant, 1.01

W₁ weight of fiber in which the chitosan fiber in the textile to be measured is deacetylated, g

W₂ weight of fiber in which the chitosan fiber in the textile to be measured is not deacetylated, g

V₁ titration volume of PVSK titrant in step 3, ml,

V₂ titration volume of PVSK titrant in step 4, ml,

W₃ weight of the solution which is weighed in step 2, 5 g in an embodiment of the present invention

W grams of the textile to be measured, g

161.15 relative molecular mass of a sugar unit in chitosan

203.19 relative molecular mass of a sugar unit in chitin

D·D deacetylation degree (abbreviated as D·D) of chitosan (fiber)

g content of chitosan fiber in textile, %

### DETAILED DESCRIPTION OF THE EMBODIMENTS

The method for measuring content of chitosan fiber in textile provide in the present invention will be described in detail hereinafter.

### First Embodiment

Step 1: a textile to be measured containing chitosan fiber of a constant weight of 1 g is weighed with a 0.1 mg electronic balance. The ratio of its constituents chitosan fiber/Newdal viscose/cotton is 10/30/60. The deacetylation degree (abbreviated as D·D) of chitosan fiber is 93%. The textile to be measured is cut up and put into a 100 ml conical flask. Then, 1% acetic acid solution of 100 ml is added to dissolve chitosan fiber in the textile to be measured.

As an optimized measure of this step, during the step of dissolving, it is preferably to stir the textile to be measured for 4 hours, and then stand for 0.5 hour, so that the chitosan fiber in the textile to be measured sufficiently dissolves in the acetic acid solution.

Step 2: 5 g of the resulting solution in step 1 is accurately weighed with a 0.1 mg electronic balance, and put into a 150 ml conical flask. 50 ml deionized water is added, and then 2-3 droplets of an indicator of Toluidine Blue are added to get ready for use. The Toluidine Blue is manufactured under the trademark of “Hushi”( [symbol] ) by Sinopharm Chemical Reagent Co. Ltd of Shanghai. The Toluidine Blue indicator has a concentration of 0.1%, and the solvent is deionized water.

Step 3: a magnetic rotor is put into a conical flask containing the resulting solution in step 2, and the conical flask is put over a magnetic stirrer. A PVSK titrant is titrated while stirring. The titration volume V₁ of PVSK titrant at the titration end-point is read as 11.23 ml. The titration end-point is defined as a time instant at which the solution turns from blue to purplish red, does not fade in 20 seconds, and forms flocculent precipitates.

The PVSK titrant is manufactured under a trade name of PVSK titrant and code No. 162-21655 by Wako Pure Chemical Industries, Ltd. of Japan.

As an optimized measure of this step, during titrating the PVSK titrant, it is preferably to control the titration rate at 0.03 ml/s, since the phenomenon of temporary titration end-point tends to appear in case the titration rate is too large.

Step 4: deionized water with the same amount as that in step 2 is taken to carry out a blank titration in the same manner as described above, and the titration volume V₂ of PVSK titrant is read as 0.15ml.

Step 5: the content of chitosan fiber in textile is calculated according to the following equations:

$$\begin{matrix}{W}_{1} = C \times f \times ( {V}_{1} - {V}_{2} ) \times 0.001 \times 161.15 \times 100 / {W}_{3} \\ = 0.0025 \times 1.01 \times ( 11.23 ml - 0.15 ml ) \times 0.001 \times \\ 161.15 \times 100 / 5 \\ = 9.02 \times {10}^{- 2}\end{matrix}$$

$$\begin{matrix}{W}_{2} = C \times f \times ( {V}_{1} - {V}_{2} ) \times 0.001 \times 203.19 \times \\ 100 / {W}_{3} \times ( 1 - D \cdot D ) / D \cdot D \\ = 0.0025 \times 1.01 \times ( 11.23 ml - 0.15 ml ) \times \\ 0.001 \times 203.19 \times 100 / 5 \times ( 1 - 93 \% ) / 93 \% \\ = 8.56 \times {10}^{- 3}\end{matrix}$$

$$\begin{matrix}g = ( {W}_{1} + {W}_{2} ) / W \times 100 \% \\ = ( 9.02 \times {10}^{- 2} + 8.56 \times {10}^{- 3} ) / 1 \times 100 \% \\ = 9.88 \% .\end{matrix}$$

The error is 10%−9.88%=0.12%.

### Second Embodiment

Step 1: a textile to be measured containing chitosan fiber of a constant weight of 0.6 g is weighed with a 0.1 mg electronic balance. The ratio of its constituents chitosan fiber/cotton is 15/85. The deacetylation degree (abbreviated as D·D) of chitosan fiber is 93%. The textile to be measured is cut up and put into a 100 ml conical flask. Then, 1% acetic acid solution of 100 ml is added to dissolve chitosan fiber in the textile to be measured.

It is preferably to stir the textile to be measured for 4 hours, and then stand for 0.5 hour, so as to sufficiently dissolve the chitosan fiber in the textile to be measured.

Step 2: 5 g of the resulting solution in step 1 is accurately weighed with a 0.1 mg electronic balance, and put into a 150 ml conical flask. 50 ml deionized water is added, and then 2-3 droplets of an indicator of Toluidine Blue are added to get ready for use. The Toluidine Blue is manufactured under the trademark of “Hushi”( [symbol] ) by Sinopharm Chemical Reagent Co. Ltd of Shanghai. The Toluidine Blue indicator has a concentration of 0.1%, and the solvent is deionized water.

Step 3: a magnetic rotor is put into a conical flask containing the resulting solution in step 2, and the conical flask is put over a magnetic stirrer. A PVSK titrant is titrated while stirring. It is preferably to control the titration rate at 0.03 ml/s, since the phenomenon of temporary titration end-point tends to appear in case the titration rate is too large. The titration volume V₁ of PVSK titrant at the titration end-point is read as 10.30 ml. The titration end-point is defined as a time instant at which the solution turns from blue to purplish red, does not fade in 20 seconds, and forms flocculent precipitates.

The PVSK titrant is manufactured under a trade name of PVSK titrant and code No. 162-21655 by Wako Pure Chemical Industries, Ltd. of Japan.

Step 4: 50 ml deionized water is taken to carry out a blank titration in the same manner as described above, and the titration volume V₂ of PVSK titrant is read as 0.15ml.

Step 5: the content of chitosan fiber in textile is calculated according to the following equations:

$$\begin{matrix}{W}_{1} = C \times f \times ( {V}_{1} - {V}_{2} ) \times 0.001 \times 161.15 \times 1008 / {W}_{3} \\ = 0.0025 \times 1.01 \times ( 10.30 ml - 0.15 ml ) \times \\ 0.001 \times 161.15 \times 100 / 5 \\ = 8.26 \times {10}^{- 2}\end{matrix}$$

$$\begin{matrix}{W}_{2} = C \times f \times ( {V}_{1} - {V}_{2} ) \times 0.001 \times 203.19 \times 100 / {W}_{3} \times \\ ( 1 - D \cdot D ) / D \cdot D \\ = 0.0025 \times 1.01 \times ( 10.30 ml - 0.15 ml ) \times 0.001 \times \\ 203.19 \times 100 / 5 \times ( 1 - 93 \% ) / 93 \% \\ = 7.84 \times {10}^{- 3}\end{matrix}$$

$$\begin{matrix}g = ( {W}_{1} + {W}_{2} ) / W \times 100 \% \\ = ( 8.26 \times {10}^{- 2} + 7.84 \times {10}^{- 3} ) / 0.6 \times 100 \% \\ = 15.07 \% .\end{matrix}$$

The error is 15.07%−15%=0.07%,

The reason for the error in the above measurement examples lies in the following aspects. Firstly, there is irregularity in the blended fabric. Secondly, there is a difference in the titration end-point due to the personal visual error. Thirdly, there is a difference in reading the scale of instrument due to the personal visual error.

1. A method for measuring content of chitosan fiber in textile, characterized in that, the method comprises:
step 1: weighing a textile to be measured of a constant weight not more than 2 g, putting into a conical flask, adding 100 ml 1% acetic acid solution to dissolve chitosan fiber in the textile to be measured, and getting ready for use;
step 2: weighing the resulting solution in step 1 and putting into another conical flask, further adding deionized water, then adding an indicator of Toluidine Blue, and getting ready for use;
step 3: putting a magnetic rotor into a conical flask containing the resulting solution in step 2, putting the conical flask over a magnetic stirrer; titrating a PVSK titrant and stirring at the same time, and reading the titration volume V₁ of PVSK titrant at the titration end-point, wherein the titration end-point is defined as a time instant at which the solution turns from blue to purplish red, does not fade in 20 seconds, and forms flocculent precipitates;
step 4: getting deionized water with the same amount as that in step 2, carrying out a blank titration in the same manner as described above, and reading the titration volume V₂ of PVSK titrant
step 5: calculating the content of chitosan fiber in textile according to the following equations:
W₁=C×f×(V₁−V₂)×0.001×161.15×100/W₃
W₂=C×f×(V₁−V₂)×0.001×203.19×100/W₃×(1−D·D)/D·D
g=(W₁+W₂)/W×100%

2. The method according to claim 1, characterized in that, in said step 1, during the step of dissolving, the textile to be measured is stirred for 4 hours, and then stands for 0.5 hour.

3. (canceled)

4. The method according to claim 1, characterized in that, in said step 3, during titrating the PVSK titrant, the titration rate is controlled at 0.03 ml/s.

5. The method according to claim 2, characterized in that, in said step 3, during titrating the PVSK titrant, the titration rate is controlled at 0.03 ml/s.
